(19) United States
(12) Patent Application Publication
(10) Pub. No.: US 2018/0156913 A1
(43) Pub. Date: Jun. 7, 2018

(54) OBJECT DETECTION APPARATUS AND OBJECT DETECTION METHOD

(71) Applicant: DENSO CORPORATION, Kariya-city, Aichi-pref. (JP)

(72) Inventor: Takahiro Baba, Kariya-city, Aichi-pref. (JP)

(21) Appl. No.: 15/577,189

(22) PCT Filed: May 27, 2016
(86) PCT No.: PCT/JP2016/065825

§ 371 Date: Nov. 27, 2017

(30) Foreign Application Priority Data
May 29, 2015 (JP) 2015-109943

(51) Int. Cl. G01S 13/86; G01S 13/93; G01S 7/41; G08G 1/16; G06K 9/00; G06K 9/34

(52) U.S. Cl. CPC G01S 13/867; G01S 13/931; G01S 7/415; G01S 7/411; G01S 2013/935; G06K 9/00805; G06K 9/34; G01S 2013/9346; G08G 1/166

(57) ABSTRACT

An object detection apparatus identifies a first area including a first detection point expressing a position of a first object detected by a radar and a second area including a second detection point expressing a position of a second object detected by a camera. A determining means determines that the first object and the second object are the same object, if an overlapping area is present in a single first area and a single second area. When a plurality of second areas have the overlapping portions with a single first area, an area selecting means selects a single first area and a single second area in which the overlapping portion is present based on a corresponding relationship between intensity of a reflected wave of the first object and a type of the second object.

### CROSS-REFERENCE TO RELATED APPLICATIONS

The present application is based on and claims the benefit of priority from Japanese Patent Application No. 2015-109943, filed on May 29, 2015, the descriptions of which are incorporated herein by reference.

### TECHNICAL FIELD

The present disclosure relates to a technology for detecting an object using a radar and a camera.

### BACKGROUND ART

A collision mitigation system for a vehicle is required to accurately detect other vehicles and objects other than vehicles, such as pedestrians. Therefore, a technology for detecting an object using a radar and a camera has been proposed (refer to, for example, PTL 1).

In the technology described in PTL 1, for each of a detection point of an object detected by a radar and a detection point of an object detected from a captured image of a camera, an area including the detection point is set, taking detection error into consideration. Then, when an overlapping portion is present in the area including the detection point of the object detected by the radar and the area including the detection point of the object detected from the captured image of the camera, the objects respectively detected by the radar and the camera are determined to be the same object.

### CITATION LIST

### Patent Literature

[PTL 1] JP-A-2014-122873

### SUMMARY OF INVENTION

When focus is placed on a single area including a detection point of an object detected by the radar, for example, when another object is present in the periphery of the object, a plurality of areas including detection points of a plurality of objects detected from a captured image of the camera may have overlapping portions with the single area of the object detected by the radar.

In a similar manner, when focus is placed on a single area including a detection point of an object detected from a captured image of the camera, a plurality of areas including detection points of a plurality of objects detected by the radar may have overlapping portions with the single area of the object detected from the captured image of the camera.

In this way, the technology described in PTL 1 does not take into consideration which object is determined to be the same in cases in which a plurality of areas including the detection points of objects detected by either of the radar and the camera have overlapping portions with a single area including the detection point of an object detected by the other of the radar and the camera.

An object of the present disclosure is to provide a technology for determining which objects are the same in cases in which a plurality of areas including detection points of objects detected by either of a radar and a camera have overlapping portions with a single area including a detection point of an object detected by the other of the radar and the camera.

An object detection apparatus according to a first aspect of the present disclosure is an object detection apparatus that is mounted to a vehicle. The object detection apparatus includes a first identifying means, a second identifying means, a determining means, and an area selecting means.

The first identifying means identifies, for a first object detected based on detection information by a radar, a first area including a first detection point expressing a position of the first object. The second identifying means identifies, for a second object detected based on a captured image by a camera, a second area including a second detection point expressing a position of the second object.

The determining means determines that the first object and the second object are the same objects if an overlapping portion in which areas overlap is present in a single first area and a single second area.

When a plurality of second areas have overlapping portions with a single first area or a plurality of first areas have the overlapping portions with a single second area, the area selecting means selects the single first area and the single second area in which the overlapping portion is present, based on a corresponding relationship between at least either of a ground speed of the first object detected by the first identifying means based on the detection information and intensity of a reflected wave of the first object detected by the first identifying means based on the detection information, and a type of the second object detected by the second identifying means based on the captured image.

In this configuration, the ground speed of the first object and the intensity of the reflected wave of the first object change based on the type of the first object. Therefore, the type of the first object can be detected based on at least either of the ground speed of the first object and the intensity of the reflected wave of the first object. In addition, the type of the second object can be detected based on the captured image of the camera, such as by pattern matching.

For example, the types of the object may be a four-wheeled automobile, a two-wheeled automobile, a bicycle, and a pedestrian. As the types of the object, the types may be separated into two classifications, such as four-wheeled automobiles and other than four-wheeled automobiles.

In addition, when the first object and the second object are the same object, the type of the first object detected based on at least either of the ground speed of the first object and the intensity of the reflected wave of the first object and the type of the second object detected based on the captured image should have a corresponding relationship.

Therefore, based on the corresponding relationship between at least either of the ground speed of the first object and the intensity of the reflected waves from the first object, and the type of the second object, the single first area and the single second area in which the overlapping portion is present, which is the condition under which the determining means determines that the first object and the second object are the same object, can be selected.

In addition, as a result of an object detection method according to the first aspect of the present disclosure, effects similar to the effects already described regarding the object detection apparatus according to the first aspect of the present disclosure can be achieved for reasons similar to those described above.

Reference numbers within the parentheses in the claims indicate corresponding relationships with specific means according to an embodiment described below as an aspect, and do not limit the technical scope of the present invention.

### BRIEF DESCRIPTION OF DRAWINGS

The above-described object, other objects, characteristics, and advantages of the present disclosure will clarified through the detailed description below, with reference to the accompanying drawings. In the drawings:

FIG. 1 is a block diagram of a collision mitigation system according to a first embodiment;

FIG. 2 is a flowchart of a collision mitigation process according to the first embodiment;

FIG. 3 is a flowchart of an object detection process according to the first embodiment;

FIG. 4 is an explanatory diagram of respective detection results of a radar and a camera regarding an object according to the first embodiment;

FIG. 5 is an explanatory diagram of respective detection results of a radar and a camera regarding an object according to a second embodiment;

FIG. 6 is a flowchart of an object detection process according to the second embodiment;

FIG. 7 is a flowchart of another object detection process according to the second embodiment; and

FIG. 8 is an explanatory diagram of respective detection results of a radar and a camera regarding an object according to another embodiment.

### DESCRIPTION OF EMBODIMENTS

Embodiments to which the present invention is applied will hereinafter be described with reference to the drawings.

### 1. First Embodiment

### [1-1. Configuration]

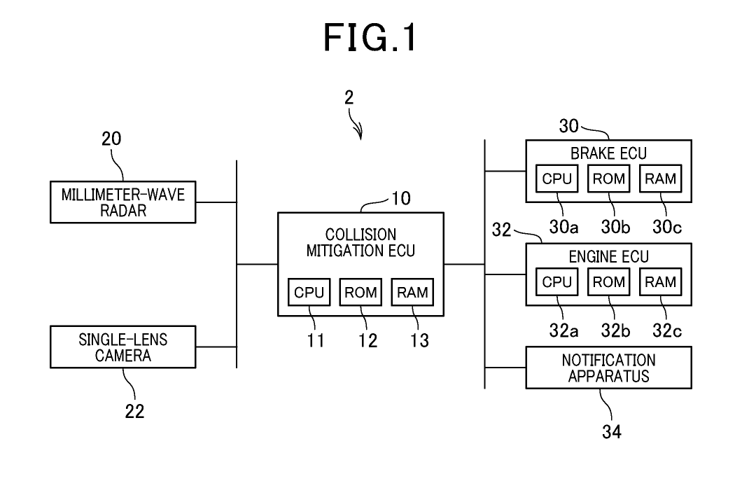

A collision mitigation system 2 shown in FIG. 1 is mounted to a vehicle, such as a passenger car. The collision mitigation system 2 includes a collision mitigation electronic control unit (ECU) 10, a millimeter-wave radar 20, a single-lens camera 22, a brake ECU 30, an engine ECU 32, and a notification apparatus 34.

The collision mitigation ECU 10 that functions as an object detection apparatus is communicably connected to each of the millimeter-wave radar 20, the single-lens camera 22, the brake ECU 30, the engine ECU 32, and the notification apparatus 34. A configuration for actualizing communication is not particularly limited.

The collision mitigation ECU 10 includes a central processing unit (CPU) 11, a read-only memory (ROM) 12, a random access memory (RAM) 13, and the like. The collision mitigation ECU 10 performs integrated control of the collision mitigation system 2. The collision mitigation ECU 10 receives a radar signal from the millimeter-wave radar 20 and an image signal from the single-lens camera 22 every fixed amount of time, based on a master clock of the CPU 11.

The millimeter-wave radar 20 is a radar for detecting another vehicle or an object other than another vehicle, such as a pedestrian, using millimeter waves. For example, the millimeter-wave radar 20 is attached to the center of a front grille on a front side of an own vehicle in which the collision mitigation system 2 is mounted. The millimeter-wave radar 20 transmits millimeter waves ahead of the own vehicle while scanning the millimeter waves within a horizontal plane. The millimeter-wave radar 20 then transmits transmission/reception data to the collision mitigation ECU 10 as detection information. The transmission/reception information is acquired through reception of reflected millimeter waves.

The single-lens camera 22 includes a single charge-coupled device (CCD) camera. For example, the single-lens camera 22 is attached near the center of a mirror on a windshield inside a cabin of the own vehicle. The single-lens camera 22 transmits data of a captured image that has been captured by the CCD camera to the collision mitigation ECU 10 as the image signal.

The brake ECU 30 includes a CPU 30a, a ROM 30b, a RAM 30c, and the like. The brake ECU 30 controls braking of the own vehicle. Specifically, the brake ECU 30 controls a brake actuator (ACT) based on a detection value of a sensor that detects a depression amount of a brake pedal. The brake ACT is an actuator that opens and closes a pressure-increase control valve and a pressure-decrease control valve provided in a brake hydraulic circuit. In addition, the brake ECU 30 controls the brake ACT such as to increase braking force of the own vehicle based on a command from the collision mitigation ECU 10.

The engine ECU 23 includes a CPU 32a, a ROM 32b, a RAM 32c, and the like. The engine ECU 32 controls startup, stopping, a fuel injection amount, an ignition timing, and the like of an engine. Specifically, the engine ECU 32 controls a throttle ACT based on a detection value of a sensor that detects a depression amount of an accelerator pedal. The throttle ACT is an actuator that opens and closes a throttle provided in an intake pipe. In addition, the engine ECU 32 controls the throttle ACT such as to reduce driving force of an internal combustion engine based on a command from the collision mitigation ECU 10.

The notification apparatus 34 issues a notification to a driver of the vehicle by sound, light, and the like upon receiving a warning signal from the collision mitigation ECU 10.

### [1-2. Processes]

### (1) Collision Mitigation Process

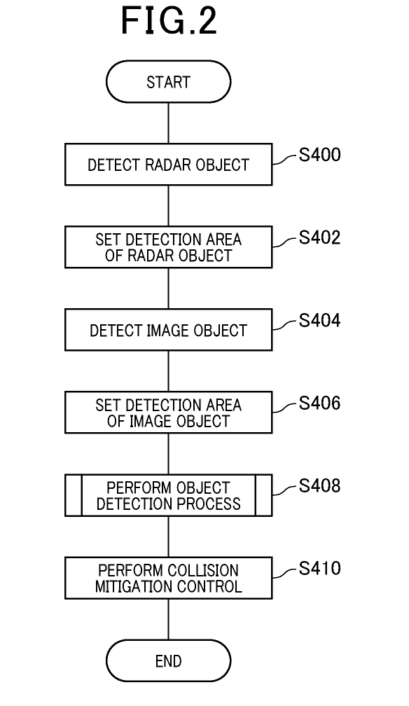

Next, a collision mitigation process by the collision mitigation ECU 10 will be described. A collision mitigation program that is a program for mitigating a collision with an object is stored in the ROM 12 and the RAM 13 of the collision mitigation ECU 10. Hereafter, the collision mitigation process performed by the CPU 11 of the collision mitigation ECU 10 based on the collision mitigation program will be described with reference to a flowchart in FIG. 2. The process shown in FIG. 2 is repeatedly performed at a predetermined cycle.

At S400 in FIG. 2, the collision mitigation ECU 10 detects an object to be detected based on detection information. The detection information is millimeter-wave radio waves transmitted from the millimeter-wave radar 20 and reflected waves reflected from the object to be detected. Specifically, the collision mitigation ECU 10 calculates and identifies a linear distance from the own vehicle to the object and a horizontal azimuth position based on the detection information. The horizontal azimuth position is expressed by an angular position (θ) of a target object with reference to a forward direction of the own vehicle.

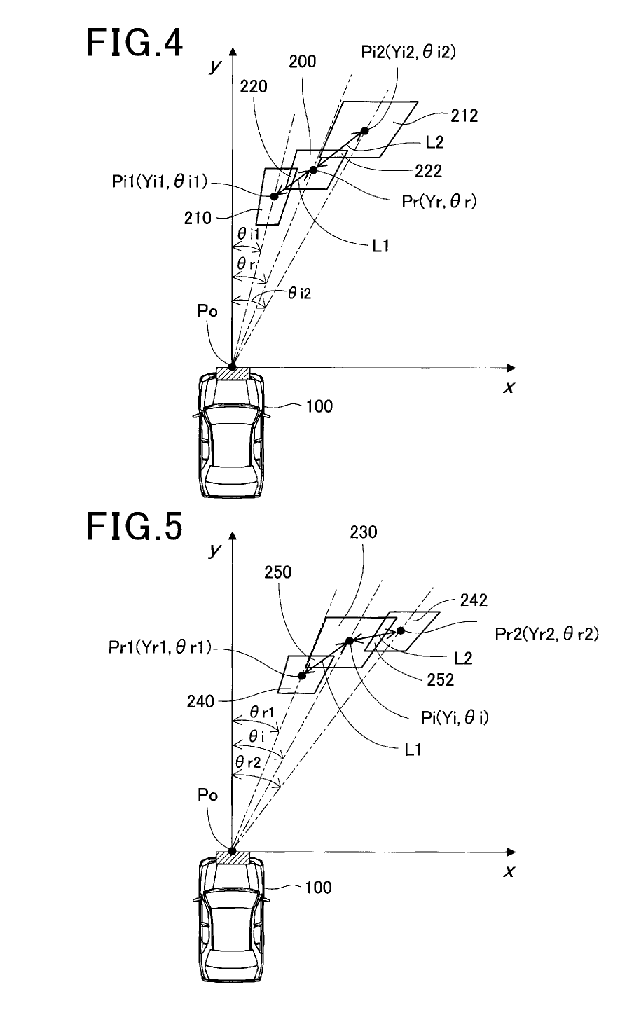

In addition, as shown in FIG. 4, positional coordinates of the object on an XY plane are calculated and identified based on the foregoing calculation values, as a detection point Pr of the object on the XY plane. The detection point Pr detected by the millimeter-wave radar 20 corresponds to a first detection point recited in the claims. The XY plane is prescribed by an X axis in which a vehicle width direction of an own vehicle 100 is a lateral direction, and a Y axis in which a vehicle length direction of the own vehicle 100 is a forward direction.

Furthermore, on the XY plane, a tip end position of the own vehicle in which the millimeter-wave radar 20 is provided is set as a reference point Po. The position of the detection point Pr of the object is expressed as a relative position to the reference point Po. FIG. 4 shows an example of an object positioned ahead of and to the right of the own vehicle.

Furthermore, at S400, the collision mitigation ECU 10 calculates, in addition to the detection point Pr of the object, a ground speed of the object from a relative speed to the object and a speed of the own vehicle. In the description hereafter, the object detected based on the detection information from the millimeter-wave radar 20 at S400 is referred to as a “radar object”.

At S402 in FIG. 2, the collision mitigation ECU 10 identifies a detection area 200 of which the detection point Pr of the radar object detected at S400 is the center. The detection area 200 corresponds to a first area recited in the claims.

Specifically, with reference to the Y coordinate of the detection point Pr and the horizontal azimuth position of the radar object, the collision mitigation ECU 10 identifies an area that is given a width amounting to an assumed error set in advance based on the characteristics of the millimeter-wave radar 20 for each of the Y coordinate and the horizontal azimuth position, as the detection area 200.

For example, when the detection point Pr is (Yr, θr), the assumed error of the Y coordinate is ±EYr, and the assumed error of the horizontal azimuth position (θ) is ±Eθr, the detection area 200 is such that the range of the Y coordinate is expressed by Yr−EYr≤Y≤Yr+EYr and the range of the horizontal azimuth position is expressed by θr−Eθr≤θ≤θr+Eθr.

That is, the range of the horizontal azimuth of the detection area 200 is set in an azimuth range of 2Eθr that includes the horizontal azimuth position θr with respect to the reference point Po. In addition, the range in the Y-axis direction of the detection area 200 is set as a Y-coordinate range of 2EYr in the Y-axis direction that includes Yr, which is the Y coordinate of the detection point Pr of the radar object on the XY plane.

At S404, the collision mitigation ECU 10 detects an object based on a captured image captured by the single-lens camera 22. Specifically, the collision mitigation ECU 10 analyzes the captured image and identifies the object. For example, the identification is performed by a pattern matching process using a dictionary of object models stored in advance being performed.

The object model is prepared for each type of object, such as a vehicle and a pedestrian. Therefore, the type of the object is identified by the pattern matching process. In addition, the collision mitigation ECU 10 identifies the Y coordinate on the above-described XY plane based on a position of the object in an up/down direction in the captured image, and identifies the horizontal azimuth position based on a position of the object in a left/right direction in the captured image. The horizontal azimuth position is expressed by the angular position of the target object with reference to the forward direction of the own vehicle.

That is, a lower end position of the object in the captured image tends to be positioned on an upper end side of the captured image, as the Y coordinate of the position of the object in the forward direction of the own vehicle becomes greater, or in other words, as the object becomes farther away. Therefore, the Y coordinate can be identified when the lower end position of the object in the captured image is known. However, such an identification method is characteristic in that detection accuracy of the Y coordinate decreases when the lower end position of the object is not accurately detected.

In addition, shifting of the object in the left/right direction with reference to a focus of expansion (FOE) of the single-lens camera 22 tends to increase as shifting of an angular direction of the object with reference to the forward direction of the own vehicle expressed by a straight line that is X=0, that is, tilt increases. Therefore, the horizontal azimuth position of the object can be identified based on an angle of a straight line that passes through Po and the object with reference to the straight line that is X=0, and a distance to a vertical line that passes through the center of the object.

That is, as shown in FIG. 4, at S404, the collision mitigation ECU 10 identifies the Y coordinate and the horizontal azimuth position of the object on the XY plane as the position of the detection point Pi of the object on the XY plane. The position of the detection point Pi of the object is expressed as a relative position to the reference point Po. In FIG. 4, two detection points Pi1 and Pi2 detected by the single-lens camera 22 are shown. The detection points Pi1 and Pi2 detected by the single-lens camera 22 correspond to a second detection point recited in the claims.

In the description hereafter, the object detected based on the captured image by the single-lens camera 22 at S404 is referred to as an “image object”.

Next, detection areas 210 and 212 of which the detection points Pi1 and Pi2 of the image objects detected at S404 in FIG. 2, and a detection point Pi according to a second embodiment, described hereafter, are the centers are set (S406).

Specifically, with reference to the Y coordinates and the horizontal azimuth positions of the detection points Pi1 and Pi2, the collision mitigation ECU 10 sets areas respectively given a width amounting to an assumed error set in advance based on the characteristics of the single-lens camera 22 for each of the Y coordinates and the horizontal azimuth positions, as the detection areas 210 and 212. The detection areas 210 and 212 correspond to a second area recited in the claims.

The setting of the detection areas 210 and 212 with the detection points Pi1 and Pi2 by the single-lens camera 22 as the centers is performed in a manner similar to the setting of the detection area 200 by the millimeter-wave radar 20, described above.

Taking the detection area 210 of the detection point Pi1 shown in FIG. 4 as an example, when the detection point Pi1 is (Yi1, θi1), the assumed error of the Y coordinate is ±EYi1, and the assumed error of the horizontal azimuth position θ is ±Eθi1, the detection area 210 is such that the range of the Y coordinate is expressed by Yi1−EYi1≤Y≤Yi1+EYi1 and the range of the horizontal azimuth position is expressed by θi1−Eθi1≤θ≤θi1+Eθi1.

Next, at S408 in FIG. 2, the collision mitigation ECU 10 performs a detection process regarding an object based on the radar object detected by the millimeter-wave radar 20 and the image object detected by the single-lens camera 22. The object detection process at S408 will be described hereafter.

When the object detection process at S408 is performed, at S410, the collision mitigation ECU 10 performs collision mitigation control based on the position of the detected object and a reliability level of the detection result of the object. For example, when a collision with the object is likely, the collision mitigation ECU 10 transmits a warning signal to the notification apparatus 34 and makes the notification apparatus 34 issue a notification to the driver. In addition, when the likelihood of a collision with the object is high, the collision mitigation ECU 10 issues a command to the engine ECU 32 to reduce the driving force of the internal combustion engine and issues a command to the brake ECU 30 to increase the braking force of the own vehicle.

Then, the collision mitigation ECU 10 varies control mode based on the reliability level. For example, when the reliability level is high, the timing for control is made earlier than that when the reliability level is low. Here, the reliability level of the detection result of the object refers to a reliability level of a determination result indicating that the radar object detected by the millimeter-wave radar 20 and the image object detected by the single-lens camera 22 are the same object. The reliability level of the determination result will be described in the object detection process described hereafter.

### (2) Object Detection Process

The object detection process performed at S408 in FIG. 2 will be described.

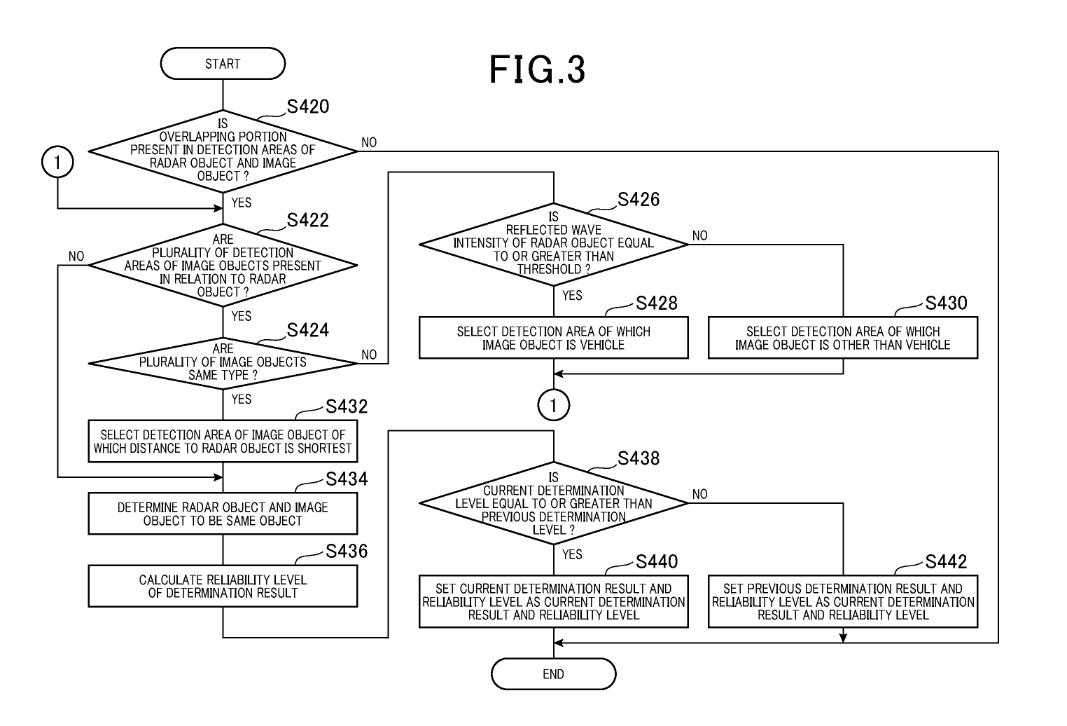

At S420 in FIG. 3, the collision mitigation ECU 10 determines whether or not an overlapping portion is present in the detection areas of the radar object and the image object. When determined that an overlapping portion is not present (No at S420), the collision mitigation ECU 10 determines that the radar object and the image object are differing objects rather than the same object because the distance between the radar object and the image object is too far. The collision mitigation ECU 10 then ends the present process. In this case, at S410 in FIG. 2, the collision mitigation ECU 10 performs separate collision mitigation control for the radar object and the image object.

When determined that an overlapping portion is present (Yes at S420), the collision mitigation ECU 10 determines whether or not the detection areas of a plurality of image objects have overlapping portions with the detection area of a single radar object (S422). When determined that the detection area of a single image object, rather than a plurality of image objects, has an overlapping portion with the detection area of a single radar object (No at S422), the collision mitigation ECU 10 determines that the radar object and the image object are the same object and shifts the process to S434.

When determined that the detection areas of a plurality of image objects have overlapping portions with the detection area of a single radar object (Yes at S422), the collision mitigation ECU 10 determines whether or not the types of the plurality of image objects identified by pattern matching are the same (S424). The type of the image object is identified in the process at S404 in FIG. 2.

In the example shown in FIG. 4, the detection areas 210 and 212 respectively including the detection points Pi1 and Pi2 of two image objects have overlapping portions 220 and 222 with the detection area 200 including the detection point Pr of a single radar object. The detection areas of three or more image objects may have overlapping portions with the detection area of a single radar object.

When determined that differing types are present among the plurality of image objects (No at S424), the collision mitigation ECU 10 determines whether or not intensity of the reflected wave from the radar object that is the current detection target with respect to the transmitted millimeter wave is equal to or greater than an intensity threshold that indicates that the radar object is a four-wheeled automobile (S426).

The intensity of the reflected wave from the radar object becomes stronger as a reflection surface of the radar object widens and becomes stronger as the reflection surface of the radar object becomes smoother and harder. Therefore, when the intensity threshold is appropriately set, the radar object can be classified into two types, that is, a four-wheeled automobile and an object other than the four-wheeled automobile.

When determined that the intensity of the reflected waves is equal to or greater than the intensity threshold (Yes at S426), the collision mitigation ECU 10 selects the detection area of the image object of which the type is the four-wheeled automobile, among the plurality of image objects (S428) and shifts the process to S422. The detection area of the four-wheeled automobile selected at S428 may be a plurality of detection areas.

When determined that the intensity of the reflected wave is less than the intensity threshold (No at S426), the collision mitigation ECU 10 selects the detection area of the image object of which the type is other than the four-wheeled automobile, among the plurality of image objects (S430) and shifts the process to S422. The detection area other than the four-wheeled automobile selected at S430 may be a plurality of detection areas.

As a result of the process at S428 or S430 being performed based on the determination result at S426, the detection area of an image object of the same type as the radar object corresponding to the intensity of the reflected wave from the radar object is selected.

Then, when the detection area of the image object selected at S428 or S430 is a single detection area, the determination at S422 becomes “No” when the process is shifted from S428 or S430 to S422. Therefore, the process proceeds to S434. In addition, when the detection area of the image object is a plurality of detection areas, the determinations at S422 and S424 are “Yes”. Therefore, the process proceeds to S432.

Here, when the detection area of a single radar object and the detection areas of a plurality of image objects of the same type as the radar object have overlapping portions, the image object of which the distance to the radar object is the shortest should be the same object as the radar object. Therefore, at S432, the collision mitigation ECU 10 selects the detection area of the image object of which the distance to the radar object is the shortest, and can thereby select the image object that is the same object as the radar object.

As shown in FIG. 4, the distance between the radar object and the image object is calculated as distances L1 and L2 between the detection point Pr of the millimeter-wave radar 20 and the detection points Pi1 and Pi2 of the single-lens camera 22. Then, the detection area of the image object having the shorter of the distances L1 and L2 is selected. When the image objects are three or more, the detection area of the image object of which the distance to the radar object is the shortest is selected.

At S434, the collision mitigation ECU 10 combines the single radar object and the single image object having the overlapping portion in the detection areas. That is, a single radar object and a single image object of which the detection areas have an overlapping portion are determined to be the same object.

At S436, the collision mitigation ECU 10 calculates the reliability level that indicates reliability of the current determination result determining that the radar object and the image object are the same object at S434. The reliability level of the determination result is calculated with reference to any of (1) to (3), below.

(1) The reliability level increases as the distance between the detection points of the combined radar object and image object decreases.

(2) The reliability level increases as the area of the overlapping portion in the detection areas of the combined radar object and image object increases.

(3) The reliability level increases as the number of times that the radar object and the image object are determined to be the same object increases during a predetermined detection cycle.

At S438, the collision mitigation ECU 10 determines whether or not the reliability level of the determination result that is currently calculated is equal to or higher than the reliability level that has been previously set.

When determined that the reliability level of the determination result that is currently calculated is equal to or higher than the reliability level that has been previously set (Yes at S438), the collision mitigation ECU 10 sets the current determination result as the current determination result and sets the reliability level of the determination that is currently calculated as the current reliability level (S440).

When determined that the reliability level of the determination result that is currently calculated is lower than the reliability level that has previously been set (No at S438), the collision mitigation ECU 10 sets the previous determination result as the current determination result and sets the reliability level that has previously been set as the current reliability level (S442).

### [1-3. Effects]

According to the first embodiment, focus is placed on the fact that, should the radar object and the image object be the same object, the type of the radar object that is detected based on at least either of the ground speed of the radar object and the intensity of the reflected wave of the radar object, and the type of the image object detected based on the captured image have a corresponding relationship.

Therefore, in cases in which the detection areas of a plurality of image objects, such as the detection areas 210 and 212 of two image objects according to the first embodiment, have overlapping portions with the detection area 200 of a single radar object, the detection area of the image object of the type corresponding to the intensity of the reflected wave from the radar object is selected. When the selected image object is also a plurality of image objects, the detection area of the image object of which the distance to the radar object is the shortest is selected.

As a result, even in cases in which the detection areas of a plurality of image objects have overlapping portions with the detection area of a single radar object, the detection area of a single appropriate image object corresponding to the type of the radar object can be selected. Consequently, even when the detection areas of a plurality of image objects have overlapping portions with the detection area of a single radar object, the single radar object and the single image object that has been selected can be determined to be the same object.

### 2. Second Embodiment

### [2-1. Processes]

A configuration of the collision mitigation system 2 according to a second embodiment is essentially identical to that of the collision mitigation system 2 according to the first embodiment. Therefore, a description thereof is omitted. According to the second embodiment, the object detection process performed at S408 in FIG. 2 differs from that according to the first embodiment.

As shown in FIG. 5, according to the second embodiment, the object detection process of a case in which detection areas 240 and 242 including detection points Pr1 and Pr2 of a plurality of radar objects detected by the millimeter-wave radar 20 have overlapping portions 250 and 252 with a detection area 230 including a detection point Pi of a single image object detected by the single-lens camera 22 is performed. The detection areas of the image object and the radar objects are set in a manner similar to that according to the first embodiment.

### [2-2. Object Detection Process]

First, an example in which the object detection process according to the second embodiment performed at S408 in FIG. 2 is performed when the image object is other than a four-wheeled automobile (the image object being an object other than a four-wheeled automobile is also referred to, hereafter, as an “image non-vehicle”) will be described.

In the example shown in FIG. 5, when the image object is a four-wheeled automobile (the image object being an object that is a four-wheeled automobile is also referred to, hereafter, as an “image vehicle”) or the image non-vehicle, the detection areas 240 and 242 respectively including the detection points Pr1 and Pr2 of two radar objects have the overlapping portions 250 and 252 with the detection area 230 including the detection point Pi. Detection areas of three or more radar objects may have overlapping portions with the detection area of a single image object.

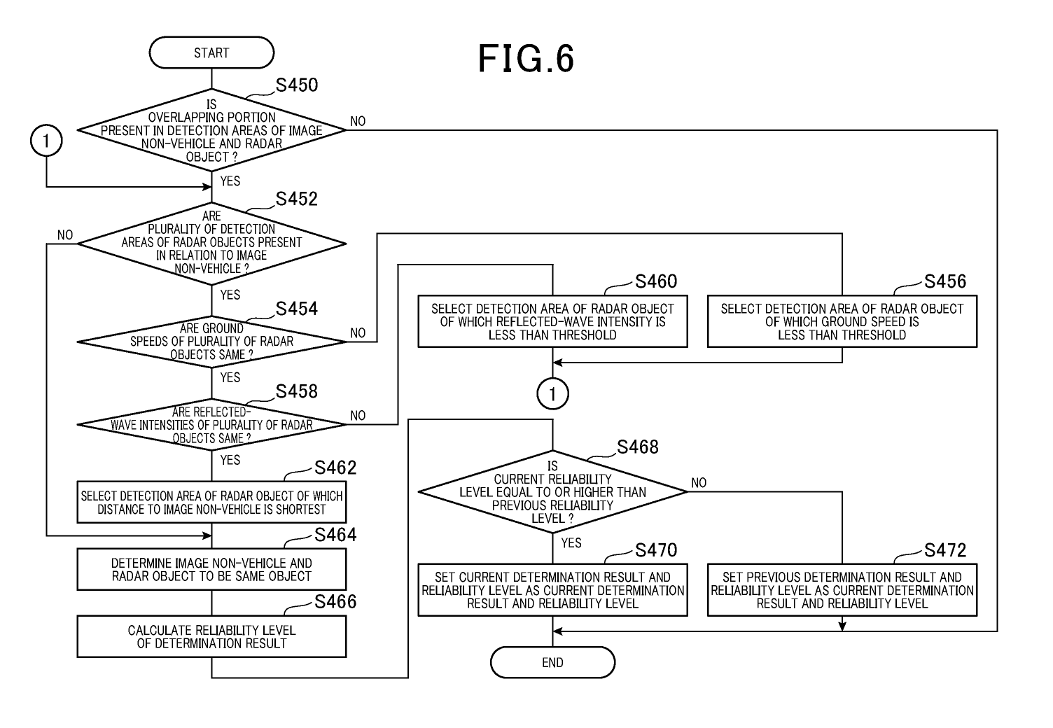

At S450 in FIG. 6, the collision mitigation ECU 10 determines whether or not an overlapping portion is present in the detection areas of the image non-vehicle and the radar object. When determined that no overlapping portion is present (No at S450), the collision mitigation ECU 10 determines that the image non-vehicle and the radar object are differing objects rather than the same object and ends the present process. In this case, at S410 in FIG. 2, the collision mitigation ECU 10 performs separate collision mitigation control for the image non-vehicle and the radar object.

When determined that an overlapping portion is present (Yes at S450), the collision mitigation ECU 10 determines whether or not the detection areas of a plurality of radar objects have overlapping portions with the detection area of a single image non-vehicle (S452). When determined that the detection area of a single radar object, rather than a plurality of radar objects, has an overlapping portion with the detection area of a single image non-vehicle (No at S452), the collision mitigation ECU 10 determines that the image non-vehicle and the radar object are the same object and shifts the process to S464.

When determined that the detection areas of a plurality of radar objects have overlapping portions with the detection area of a single image non-vehicle (Yes at S452), the collision mitigation ECU 10 determines whether or not the ground speeds of the plurality of radar objects are the same within a range taking error into consideration (S454). The ground speed of the radar object is calculated in the process at S400 in FIG. 2.

When determined that a differing ground speed is present among the ground speeds of the plurality of radar objects (No at S454), the collision mitigation ECU 10 selects a radar object of which the ground speed is less than a speed threshold indicating that the object is other than the four-wheeled automobile in correspondence to the image non-vehicle (S456). The collision mitigation ECU 10 then shifts the process to S452. The radar object other than the four-wheeled automobile selected at S456 may be a plurality of radar objects.

According to the present embodiment, when the radar object is the four-wheeled automobile, the ground speed of the radar object is faster than that other than a four-wheeled automobile. Therefore, when the speed threshold is appropriately set, the radar object can be differentiated between two types, that is, a four-wheeled automobile and an object other than the four-wheeled automobile.

When determined that the ground speeds of the plurality of radar objects are the same (Yes at S454), the collision mitigation ECU 10 determines whether or not the intensities of the reflected waves of the plurality of radar objects are the same within a range taking error into consideration (S458). When determined that the intensities of the reflected waves of the plurality of radar objects are the same (Yes at S458), the collision mitigation ECU 10 shifts the process to S462.

When determined that a differing intensity is present among the intensities of the reflected waves of the plurality of radar objects (No at S458), the collision mitigation ECU 10 selects a radar object of which the intensity of the reflected wave is less than an intensity threshold indicating that the object is other than the four-wheeled automobile (S460). The collision mitigation ECU 10 shifts the process to S452. The radar object other than the four-wheeled automobile selected at S460 may be a plurality of radar objects.

As a result of the process at S456 being performed based on the determination result at S454 and the process at S460 being performed based on the determination result at S458, the detection area of the radar object of which the ground speed or the intensity of the reflected wave corresponds to the image non-vehicle is selected.

Then, when the detection area of the radar object selected at S456 or S460 is a single detection area, the determination at S452 is “No” when the process is shifted from S456 or S460 to S452. Therefore, the process proceeds to S464. In addition, when the selected detection area of a radar object is a plurality of detection areas, the determinations at S452, S454, and S458 are “Yes”. Therefore, the process proceeds to S462.

Here, when the detection area of a single image non-vehicle and the detection areas of a plurality of radar objects of the same type as the image non-vehicle have overlapping portions, the radar object of which the distance to the image non-vehicle is the shortest should be the same object as the image non-vehicle. Therefore, at S462, the collision mitigation ECU 10 selects the detection area of the radar object of which the distance to the image non-vehicle is the shortest, and can thereby select the radar object that is the same object as the image non-vehicle.

As shown in FIG. 5, the distance between the image non-vehicle and the radar object is calculated as distances L1 and L2 between the detection points Pr1 and Pr2 of the millimeter-wave radar 20 and the detection point Pi of the single-lens camera 22. Then, the detection area of the radar object having the shorter of the distances L1 and L2 is selected. When the radar objects are three or more, the detection area of the radar object of which the distance to the image non-vehicle is the shortest is selected.

At S464, the collision mitigation ECU 10 combines the single radar object and the single image object having the overlapping portion in the detection areas. That is, the single radar object and the single image non-vehicle of which the detection areas have an overlapping portion are determined to be the same object.

At S466, the collision mitigation ECU 10 calculates the reliability level that indicates reliability of the current determination result determining that the radar object and the image non-vehicle are the same object at S464. The reliability level of the determination result is the same as the bases (1) to (3) described according to the first embodiment.

The processes at S468 to S472 are essentially identical to the processes at S438 to S442 in FIG. 3 according to the first embodiment, described above. Therefore, descriptions thereof are omitted.

### (2) When the Image Object is a Four-Wheeled Automobile

Next, an example in which the object detection process according to the second embodiment performed at S408 in FIG. 2 is performed when the image object is the image vehicle, which is the four-wheeled vehicle, will be described.

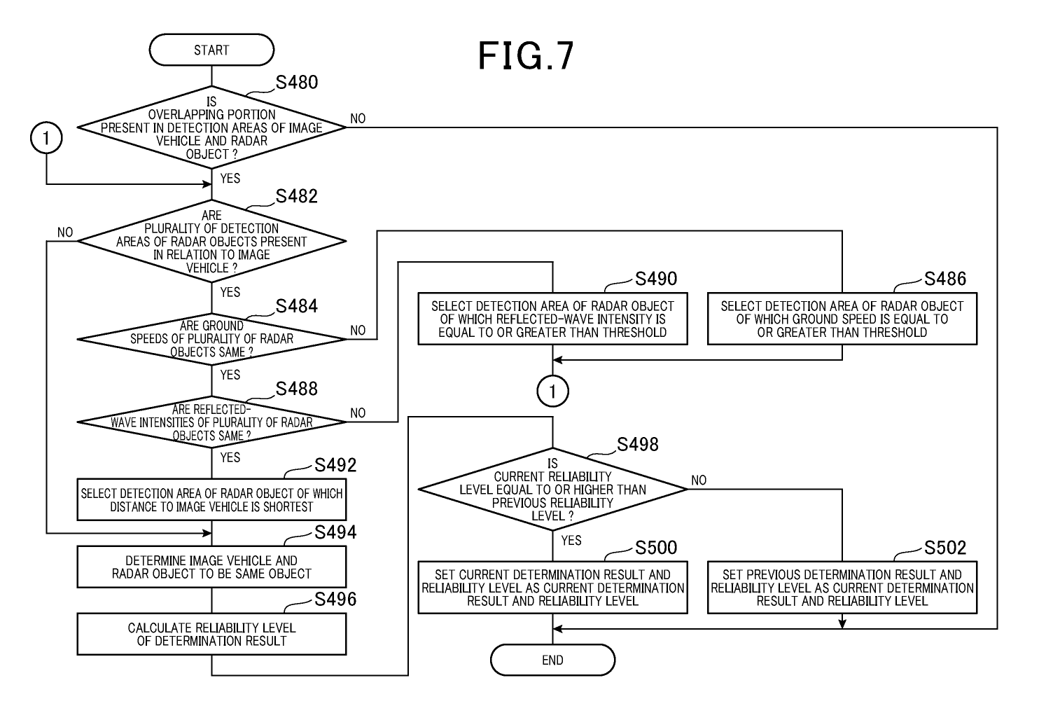

At S480 in FIG. 7, the collision mitigation ECU 10 determines whether or not an overlapping portion is present in the detection areas of the image vehicle and the radar object. When determined that an overlapping portion is not present (No at S480), the collision mitigation ECU 10 determines that the image vehicle and the radar object are differing objects rather than the same object and ends the present process. In this case, at S410 in FIG. 2, the collision mitigation ECU 10 performs separate collision mitigation control for the image vehicle and the radar object.

When determined that an overlapping portion is present (Yes at S480), the collision mitigation ECU 10 determines whether or not the detection areas of a plurality of radar objects have overlapping portions with the detection area of a single image vehicle (S482). When determined that the detection area of a single radar object, rather than a plurality of radar objects, has an overlapping portion with the detection area of a single image non-vehicle (No at S482), the collision mitigation ECU 10 determines that the image vehicle and the radar object are the same object and shifts the process to S494.

When determined that the detection areas of a plurality of radar objects have overlapping portions with the detection area of a single image vehicle (Yes at S482), the collision mitigation ECU 10 determines whether or not the ground speeds of the plurality of radar objects are the same within a range taking error into consideration (S484). The ground speed of the radar object is calculated in the process at S400 in FIG. 2.

When determined that a differing ground speed is present among the ground speeds of the plurality of radar objects (No at S484), the collision mitigation ECU 10 selects a radar object of which the ground speed is equal to or greater than a speed threshold indicating that the object is a four-wheeled automobile in correspondence to the image vehicle (S486). The collision mitigation ECU 10 then shifts the process to S482. When the speed threshold is appropriately set, the radar object can be differentiated between two types, that is, a four-wheeled automobile and an object other than the four-wheeled automobile. The radar object that is a four-wheeled automobile selected at S486 may be a plurality of radar objects.

When determined that the ground speeds of the plurality of radar objects are the same (Yes at S484), the collision mitigation ECU 10 determines whether or not the intensities of the reflected waves of the plurality of radar objects are the same within a range taking error into consideration (S488). When determined that the intensities of the reflected waves of the plurality of radar objects are the same (Yes at S488), the collision mitigation ECU 10 shifts the process to S492.

When determined that a differing intensity is present among the intensities of the reflected waves of the plurality of radar objects (No at S488), the collision mitigation ECU 10 selects a radar object of which the intensity of the reflected wave is equal to or greater than an intensity threshold indicating that the object is a four-wheeled automobile (S490). The collision mitigation ECU 10 shifts the process to S482. The radar object that is a four-wheeled automobile selected at S490 may be a plurality of radar objects.

As a result of the process at S486 being performed based on the determination result at S484 and the process at S490 being performed based on the determination result at S488, the detection area of the radar object of which the ground speed or the intensity of the reflected wave corresponds to the image vehicle is selected.

Then, when the detection area of the radar object selected at S486 or S490 is a single detection area, the determination at S482 is “No” when the process is shifted from S486 or S490 to S482. Therefore, the process proceeds to S494. In addition, when the selected detection area of a radar object is a plurality of detection areas, the determinations at S482, S484, and S488 are “Yes”. Therefore, the process proceeds to S492.

Here, when the detection area of a single image vehicle and the detection areas of a plurality of radar objects of the same type as the image vehicle have overlapping portions, the radar object of which the distance to the image vehicle is the shortest should be the same object as the image vehicle.

Therefore, at S492, the collision mitigation ECU 10 selects the detection area of the radar object of which the distance to the image vehicle is the shortest, and can thereby select the radar object that is the same object as the image vehicle. The distance between the image vehicle and the radar object is calculated in a manner similar to the distance between the image non-vehicle and the radar object, described above.

At S494, the collision mitigation ECU 10 combines the single radar object and the single image vehicle having the overlapping portion in the detection areas. That is, the single radar object and the single image vehicle of which the detection areas have an overlapping portion are determined to be the same object.

At S496, the collision mitigation ECU 10 calculates the reliability level that indicates reliability of the current determination result determining that the radar object and the image vehicle are the same object at S494. The reliability level of the determination result is the same as the bases (1) to (3) described according to the first embodiment.

The processes at S498 to S502 are essentially identical to the processes at S468 to S472 in FIG. 3 according to the first embodiment, described above. Therefore, descriptions thereof are omitted.

### [2-2. Effects]

According to the second embodiment described above, the following effects can be achieved.

According to the second embodiment as well, focus is placed on the fact that, should the radar object and the image object be the same object, the type of the radar object that is detected based on at least either of the ground speed of the radar object and the intensity of the reflected wave of the radar object, and the type of the image object detected based on the captured image have a corresponding relationship, in a manner similar to that according to the first embodiment.

Therefore, in cases in which the detection areas of a plurality of radar objects, such as the detection areas 240 and 242 of two radar objects according to the second embodiment, have overlapping portions with the detection area 230 of a single image object, the radar object having the ground speed or the intensity of the reflected wave corresponding to the type of the image object is selected. When the selected radar object is also a plurality of radar objects, the detection area of the radar object of which the distance to the image object is the shortest is selected.

As a result, even in cases in which the detection areas of a plurality of radar objects have overlapping portions with the detection area of a single image object, the detection area of a single appropriate radar object corresponding to the type of image object can be selected. Consequently, even when the detection areas of a plurality of radar objects have overlapping portions with the detection area of a single image object, the single image object and the single radar object that has been selected can be determined to be the same object.

### 3. Other Embodiments

(1) In the technology according to the above-described embodiments, when the detection areas of a plurality of image objects have overlapping portions with the detection area of a single radar object or the detection areas of a plurality of radar objects have overlapping portions with the detection area of a single image object, based on the corresponding type of the radar object and the image object, the detection area of a single radar object and the detection area of a single image object are selected and determined to be the same object. This technology is not limited to the field of mitigating a collision with another object and may be applied to any kind of field.

(2) At S426 in FIG. 3, instead of the determination regarding whether or not the intensity of the reflected wave of the radar object is equal to or greater than the intensity threshold, a determination regarding whether or not the ground speed of the radar object is equal to or greater than the speed threshold may be used. The type of the image object corresponding to the type of the radar object may then be selected.

(3) Either of the processes at S484 and S486 or S488 and S490 in FIG. 7 may be omitted.

(4) Instead of the processes at S438 to S442 in FIGS. 3, S468 to S472 in FIG. 6, and S498 to S502 in FIG. 7, the current determination result may be used at all times.

(5) As long as radio waves can be transmitted and the target object can be detected with the reflected waves from the target object as the detection information, radio waves of any frequency may be used, in addition to the millimeter waves.

(6) As long as the captured image for detecting the target object is captured, a stereo camera may be used, instead of a single-lens camera.

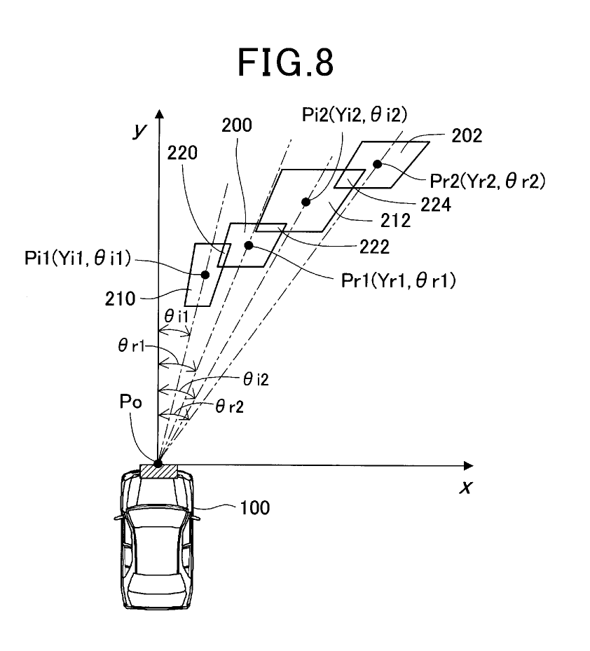

(7) As shown in FIG. 8, the following object detection process may be performed in cases in which, when focus is placed on the detection area 200 of a single radar object, the detection areas 210 and 212 of two image objects have the overlapping portions 220 and 222, and when focus is placed on the detection area 212 of a single image object, the detection areas 200 and 202 of two radar objects have overlapping areas 222 and 224.

Regarding the detection area 200 and the detection areas 210 and 212, and the detection area 212 and the detection areas 200 and 202, when the radar object of the detection area 200 and the image object of the detection area 212 are determined to be the same object in both cases, because the determination results match, the radar object of the detection area 200 and the image object of the detection area 212 are determined to be the same object.

Conversely, when the radar object of the detection area 200 and the image object of the detection area 212 are determined to be the same object regarding the detection area 200 and the detection areas 210 and 212, and the radar object of the detection area 202 and the image object of the detection area 212 are determined to be the same object regarding the detection area 212 and the detection areas 200 and 202, the determination results do not match. Therefore, the radar objects and image objects of all detection areas are determined to be differing objects.

(8) According to the above-described embodiments, the types of the radar object and the image object are classified into two types, that is, the four-wheeled automobile and other than the four-wheeled automobile. In addition, the types of the radar object and the image object may be classified into three or more types, based on identification accuracy of the objects by the radar and the camera. For example, the types of the radar object and the image object may be classified into a four-wheeled automobile, a two-wheeled automobile, a bicycle, and a pedestrian.

(9) A function provided by a single constituent element according to the above-described embodiments may be dispersed among a plurality of constituent elements. Functions provided by a plurality of constituent elements may be integrated into a single constituent element. In addition, at least a part of a configuration according to the above-described embodiments may be replaced by a publicly known configuration providing similar functions. Furthermore, a part of a configuration according to the above-described embodiments may be omitted to an extent enabling the problem to be solved. All aspects included in the technical concept identified solely by the expressions recited in the claims are embodiments of the present invention.

(10) The present invention can also be actualized by various modes in addition to the object detection apparatus actualized by the collision mitigation ECU 10, described above, such as a system of which the object detection apparatus is a constituent element, an object detection program enabling a computer to function as the object detection apparatus, a recording medium on which the object detection program is recorded, and an object detection method.

The collision mitigation ECU 10 according to each of the above-described embodiments corresponds to an object detection apparatus, a first identifying means, a second identifying means, a determining means, an area selecting means, a reliability level acquiring means, and a result selecting means recited in the claims. More specifically, in FIG. 2, the process at S402 functionally configures the first identifying means recited in the claims. The process at S406 functionally configures the second identifying means recited in the claims.

In FIG. 3, FIG. 6, and FIG. 7, the processes at S434, 464, and 494 functionally configure the determining means recited in the claims. In FIG. 3, FIG. 6, and FIG. 7, the processes at S422 to S432, S452 to S462, and S482 to S492 functionally configure the area selecting means recited in the claims. In FIG. 3, FIG. 6, and FIG. 7, the processes at S436, S466, and S496 functionally configure the reliability level acquiring means recited in the claims. In FIG. 3, FIG. 6, and FIG. 7, the processes at S438 to S442, S468 to S472, and S498 to S502 functionally configure the result selecting means recited in the claims.

In addition, the detection areas 200, 240, and 242 correspond to a first area recited in the claims. The detection areas 210, 212, and 230 correspond to a second area recited in the claims. The detection points Pr, Pr1, and Pr2 correspond to a first detection point recited in the claims. The detection points Pi, Pi1, and Pi2 correspond to a second detection point recited in the claims.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

### REFERENCE SIGNS LIST

2: collision mitigation system
10: collision mitigation ECU (object detection apparatus, first identifying means, second identifying means, determining means, area selecting means, reliability acquiring means, result selecting means)
200, 240, 242: detection area (first area)
210, 212, 230: detection area (second area)
220, 222, 250, 252: overlapping portion
Pr, Pr1, Pr2: detection point (first detection point)
Pi, Pi1, Pi2: detection point (second detection point)

1. An object detection apparatus that is mounted to a vehicle, the object detection apparatus comprising:
first identifying means that identifies, for a first object detected based on detection information by a radar, a first area including a first detection point expressing a position of the first object;
second identifying means that identifies, for a second object detected based on a captured image by a camera, a second area including a second detection point expressing a position of the second object;
determining means that determines that the first object and the second object are the same object, if an overlapping portion in which areas overlap is present in a single first area and a single second area; and
area selecting means that when a plurality of second areas have the overlapping portions with the single first area or a plurality of first areas have the overlapping portions with the single second area, selects the single first area and the single second area in which the overlapping portion is present, based on a corresponding relationship between a ground speed of the first object detected by the first identifying means based on the detection information and a type of the second object detected by the second identifying means based on the captured image.

2. The object detection apparatus according to claim 1, wherein:
when a plurality of second areas have the overlapping portions with the single first area and the types of the second objects are the same in the plurality of second areas, the area selecting means selects the single second area including the second detection point of which a distance to the first detection point is the shortest among the plurality of second detection points, as an area having the overlapping portion with the single first area.

3. The object detection apparatus according to claim 2, wherein:
when the type of the first object is detected based on the ground speed, and when a plurality of second areas have the overlapping portions with the single first area, and when a differing type is present among the types of the second objects in the plurality of second areas, the area selecting means selects the second area of one second object or more corresponding to the type of the first object, as the area having the overlapping portion with the single first area; and
when the selected second area is a plurality of second areas, the area selecting means selects a single second area including the second detection point of which the distance to the first detection point is the shortest among the plurality of second detection points included in the selected plurality of second areas.

4. The object detection apparatus according to claim 3, wherein:
when the type of the first object is detected based on the ground speed, and when a plurality of first areas have the overlapping portions with the single second area, and when the types of the first objects in the plurality of first areas are the same, the area selecting means selects a single first area including the first detection point of which the distance to the second detection point is the shortest, among the plurality of first detection points, as the area having the overlapping portion with the single second area.

5. The object detection apparatus according to claim 4, wherein:
when the type of the first object is detected based on the ground speed, and when a plurality of first areas have the overlapping portions with the single second area, and when a differing type is present among the types of the first objects in the plurality of first areas, the area selecting means selects the first area of one first object or more corresponding to the type of the second object, as the area having the overlapping portion with the single second area; and
when the selected first area is a plurality of first areas, the area selecting means selects a single first area including the first detection point of which the distance to the second detection point is the shortest among the plurality of first detection points included in the selected plurality of first areas.

6. The object detection apparatus according to claim 5, further comprising:
reliability level acquiring means that acquires a reliability level indicating reliability of a determination result determined by the determining means in which the determining means determines that the first object and the second object are the same object; and
result selecting means that uses, as a current determination result and a current reliability level, the current determination result and the current reliability level when the reliability level of the current determination result by the determining means acquired by the reliability acquiring means is equal to or higher than a previous reliability level, and the previous determination result and the previous reliability level when the reliability level of the current determination result by the determining means acquired by the reliability level acquiring means is lower than the previous reliability level.

7. An object detection method for detecting an object using an object detection apparatus that is mounted to a vehicle, the object detection method comprising:
a first identifying step of identifying, for a first object detected based on detection information by a radar, a first area including a first detection point expressing a position of the first object;
a second identifying step of identifying, for a second object detected based on a captured image by a camera, a second area including a second detection point expressing a position of the second object;
a determining step of determining that the first object and the second object are the same object, if an overlapping portion in which areas overlap is present in a single first area and a single second area; and
an area selecting step of selecting, when a plurality of second areas have the overlapping portions with the single first area or a plurality of first areas have the overlapping portions with the single second area, the single first area and the single second area in which the overlapping portion is present, based on a corresponding relationship between a ground speed of the first object detected by the first identifying step based on the detection information and a type of the second object detected by the second identifying step based on the captured image.

8. The object detection method according to claim 7, wherein:
when a plurality of second areas have the overlapping portions with the single first area and the types of the second objects are the same in the plurality of second areas, the area selecting step selects a single second area including the second detection point of which a distance to the first detection point is the shortest among the plurality of second detection points, as an area having the overlapping portion with the single first area.

9. The object detection method according to claim 8, wherein:
when the type of the first object is detected based on the ground speed, and when a plurality of second areas have the overlapping portions with the single first area, and when a differing type is present among the types of the second objects in the plurality of second areas, the area selecting step selects the second area of one second object or more corresponding to the type of the first object, as the area having the overlapping portion with the single first area; and
when the selected second area is a plurality of second areas, the area selecting step selects a single second area including the second detection point of which the distance to the first detection point is the shortest among the plurality of second detection points included in the selected plurality of second areas.

10. The object detection method according to claim 9, wherein:
when the type of the first object is detected based on the ground speed, and when a plurality of first areas have the overlapping portions with the single second area, and when the types of the first objects in the plurality of first areas are the same, the area selecting step selects a single first area including the first detection point of which the distance to the second detection point is the shortest, among the plurality of first detection points, as the area having the overlapping portion with the single second area.

11. The object detection method according to claim 10, wherein:
when the type of the first object is detected based on the ground speed, and when a plurality of first areas have the overlapping portions with the single second area, and when a differing type is present among the types of the first objects in the plurality of first areas, the area selecting means selects the first area of one first object or more corresponding to the type of the second object, as the area having the overlapping portion with the single second area; and
when the selected first area is a plurality of first areas, the area selecting means selects a single first area including the first detection point of which the distance to the second detection point is the shortest among the plurality of first detection points included in the selected plurality of first areas.

12. The object detection method according to claim 11, further comprising:
a reliability level acquiring step of acquiring a reliability level indicating reliability of a determination result determined by the determining step in which the determining step determines that the first object and the second object are the same object; and
a result selecting step of using, as a current determination result and a current reliability level, the current determination result and the current reliability level when the reliability level of the current determination result by the determining step acquired at the reliability acquiring step is equal to or higher than a previous reliability level, and the previous determination result and the previous reliability level when the reliability level of the current determination result by the determining step acquired at the reliability level acquiring step is lower than the previous reliability level.

13. The object detection apparatus according to claim 1, wherein:
when the type of the first object is detected based on the ground speed, and when a plurality of second areas have the overlapping portions with the single first area, and a when differing type is present among the types of the second objects in the plurality of second areas, the area selecting means selects the second area of one second object or more corresponding to the type of the first object, as the area having the overlapping portion with the single first area; and
when the selected second area is a plurality of second areas, the area selecting means selects a single second area including the second detection point of which the distance to the first detection point is the shortest among the plurality of second detection points included in the selected plurality of second areas.

14. The object detection apparatus according to claim 1, wherein:
when the type of the first object is detected based on the ground speed, and when a plurality of first areas have the overlapping portions with the single second area, and when the types of the first objects in the plurality of first areas are the same, the area selecting means selects a single first area including the first detection point of which the distance to the second detection point is the shortest, among the plurality of first detection points, as the area having the overlapping portion with the single second area.

15. The object detection apparatus according to claim 1, wherein:
when the type of the first object is detected based on the ground speed, and when a plurality of first areas have the overlapping portions with the single second area, and when a differing type is present among the types of the first objects in the plurality of first areas, the area selecting means selects the first area of one first object or more corresponding to the type of the second object, as the area having the overlapping portion with the single second area; and
when the selected first area is a plurality of first areas, the area selecting means selects a single first area including the first detection point of which the distance to the second detection point is the shortest among the plurality of first detection points included in the selected plurality of first areas.

16. The object detection apparatus according to claim 1, further comprising:
reliability level acquiring means that acquires a reliability level indicating reliability of a determination result determined by the determining means in which the determining means determines that the first object and the second object are the same object; and
result selecting means that uses, as a current determination result and a current reliability level, the current determination result and the current reliability level when the reliability level of the current determination result by the determining means acquired by the reliability acquiring means is equal to or higher than a previous reliability level, and the previous determination result and the previous reliability level when the reliability level of the current determination result by the determining means acquired by the reliability level acquiring means is lower than the previous reliability level.

17. The object detection method according to claim 7, wherein:
when the type of the first object is detected based on the ground speed, and when a plurality of second areas have the overlapping portions with the single first area, and when a differing type is present among the types of the second objects in the plurality of second areas, the area selecting step selects the second area of one second object or more corresponding to the type of the first object, as the area having the overlapping portion with the single first area; and
when the selected second area is a plurality of second areas, the area selecting step selects a single second area including the second detection point of which the distance to the first detection point is the shortest among the plurality of second detection points included in the selected plurality of second areas.

18. The object detection method according to claim 7, wherein:
when the type of the first object is detected based on the ground speed, and when a plurality of first areas have the overlapping portions with the single second area, and when the types of the first objects in the plurality of first areas are the same, the area selecting step selects a single first area including the first detection point of which the distance to the second detection point is the shortest, among the plurality of first detection points, as the area having the overlapping portion with the single second area.

19. The object detection method according to claim 7, wherein:
when the type of the first object is detected based on the ground speed, and when a plurality of first areas have the overlapping portions with the single second area, and when a differing type is present among the types of the first objects in the plurality of first areas, the area selecting means selects the first area of one first object or more corresponding to the type of the second object, as the area having the overlapping portion with the single second area; and
when the selected first area is a plurality of first areas, the area selecting means selects a single first area including the first detection point of which the distance to the second detection point is the shortest among the plurality of first detection points included in the selected plurality of first areas.

20. The object detection method according to claim 7, further comprising:
a reliability level acquiring step of acquiring a reliability level indicating reliability of a determination result determined by the determining step in which the determining step determines that the first object and the second object are the same object; and
a result selecting step of using, as a current determination result and a current reliability level, the current determination result and the current reliability level when the reliability level of the current determination result by the determining step acquired at the reliability acquiring step is equal to or higher than a previous reliability level, and the previous determination result and the previous reliability level when the reliability level of the current determination result by the determining step acquired at the reliability level acquiring step is lower than the previous reliability level.
